(19) United States
(12) Patent Application Publication
(10) Pub. No.: US 2026/0076341 A1
(43) Pub. Date: Mar. 19, 2026

(54) Private Pet Feeding Bowl

(71) Applicant: Bryce Garett Tiefenthaler, Wilton, CT (US)

(72) Inventor: Bryce Garett Tiefenthaler, Wilton, CT (US)

(21) Appl. No.: 19/330,562

(22) Filed: Sep. 16, 2025

Related U.S. Application Data
(60) Provisional application No. 63/695,665, filed on Sep. 17, 2024.

(51) Int. Cl. A01K 5/01

(52) U.S. Cl. CPC A01K 5/0135

(57) ABSTRACT

The present invention is a specialized feeding bowl for animals which serves to reduce the mess from sloppy eating and potential tipping of the bowl. The present invention provides a bowl with a designated entry point and higher walls around the remaining circumference of the bowl to serve as a splash guard and blocking some tipping while the bowl is being accessed.

### FIELD OF THE INVENTION

The present invention relates generally to the field of animal care and feeding articles. Specifically, the invention is a specialized bowl for feeding pets while reducing mess.

### BACKGROUND OF THE INVENTION

Some animals eat in a manner that is more chaotic than others. This can result in significant mess around feeding areas, requiring additional effort to maintain a sanitary eating space for the animals. Further, some feeding receptacles are easily upended which can result in even more mess, regardless of how it becomes overturned. Existing feeding bowls are generally structured to allow access without consideration for its user's “splash zone”while eating.

The present invention provides a uniquely shaped bowl that addresses the several concerns listed above. The bowl is structured to be utilized by a single animal at a single point of access. High walls around the non-access perimeter of the bowl serve as a splash guard girding the area from animals eating sloppily. Additionally, the walls serve to limit the angle to which a bowl can be readily tipped over by an overexcited animal stepping on its lower lip while its head is in position to the access the bowl. Finally, the walls also serve as a way to limit the sight of the animal while it is eating, which can help with animals that are easily distracted away from their feeding.

### BRIEF DESCRIPTION OF THE DRAWINGS

FIG. 1 is an exploded view for an embodiment of the present invention.

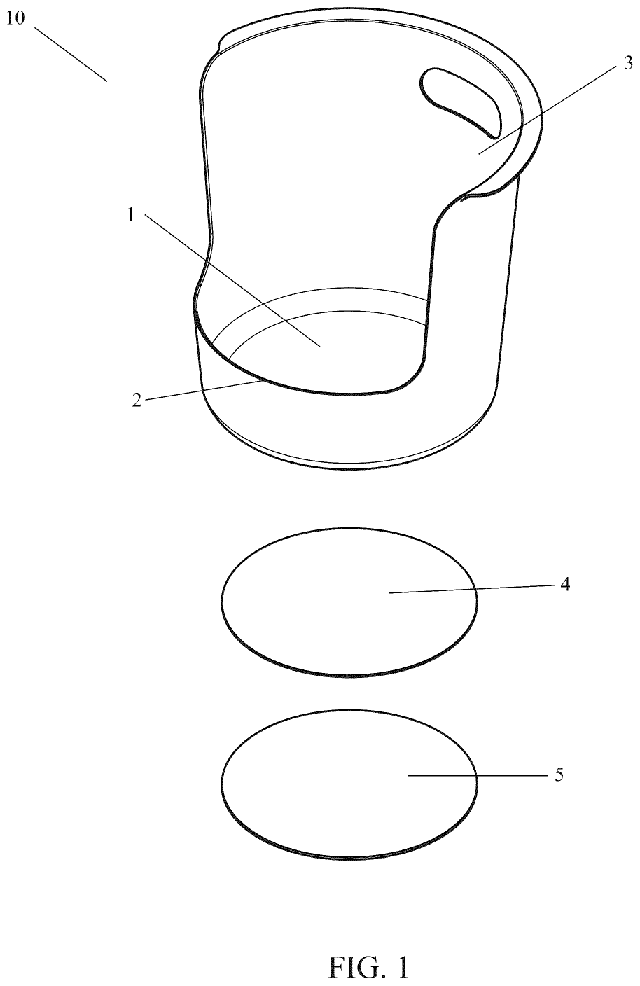

FIG. 2 is a front view for an embodiment of the present invention.

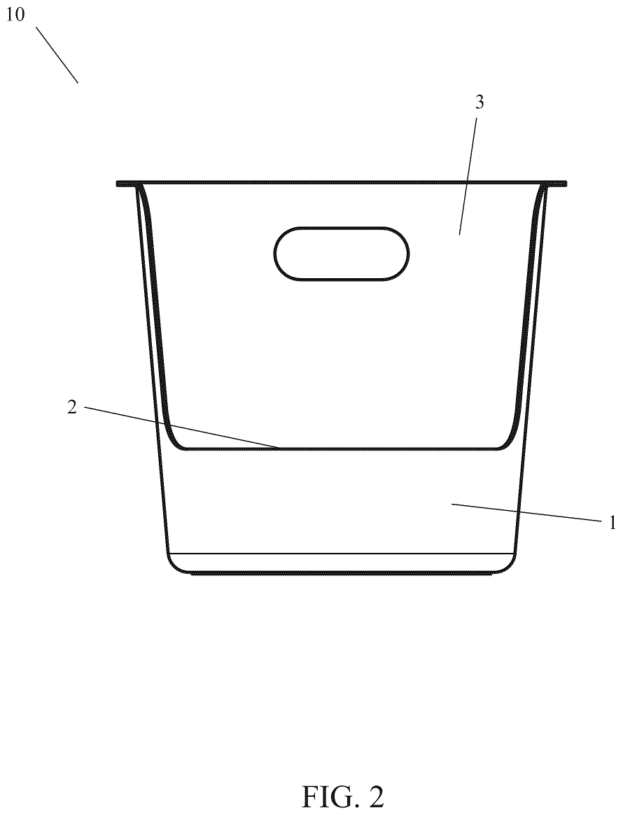

FIG. 3 is a side view for an embodiment of the present invention.

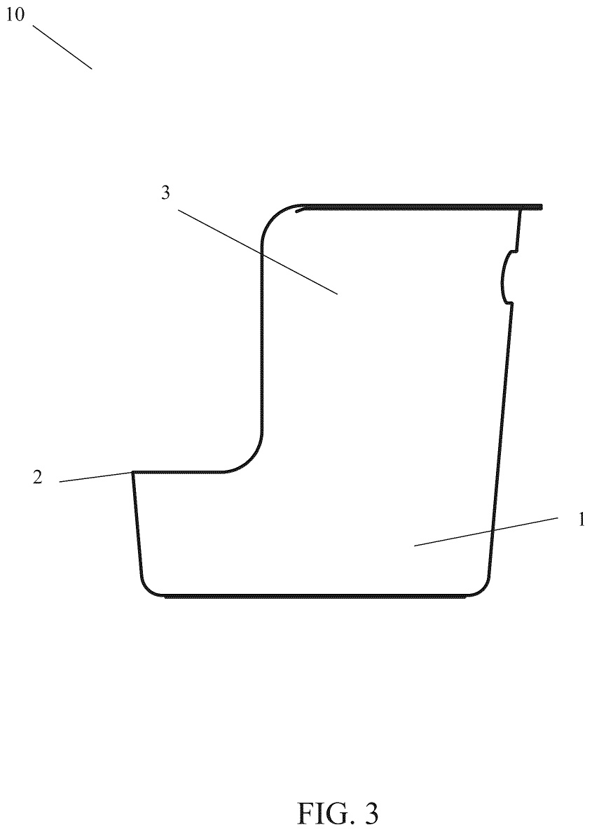

FIG. 4 is an underside view for an embodiment of the present invention.

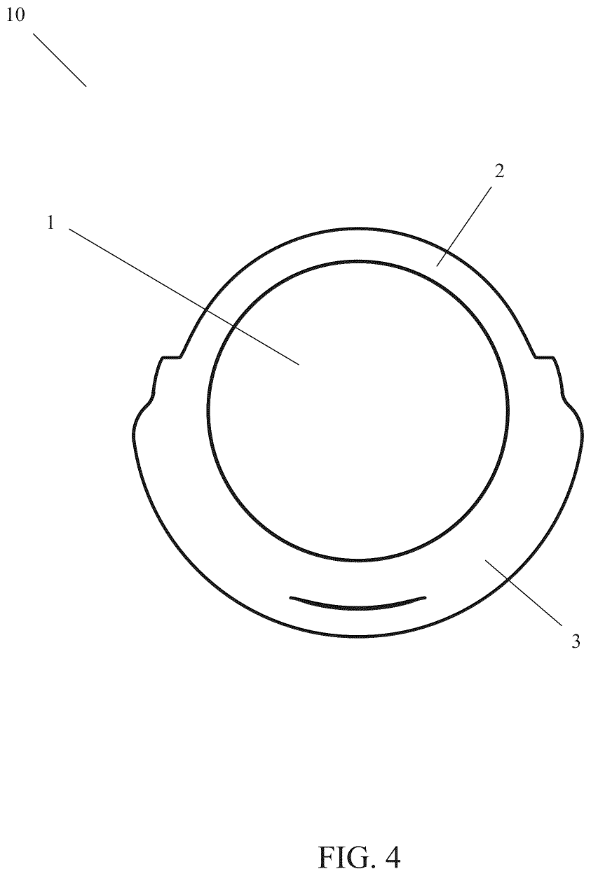

FIG. 5 is a lower-left side offset view for an embodiment of the present invention.

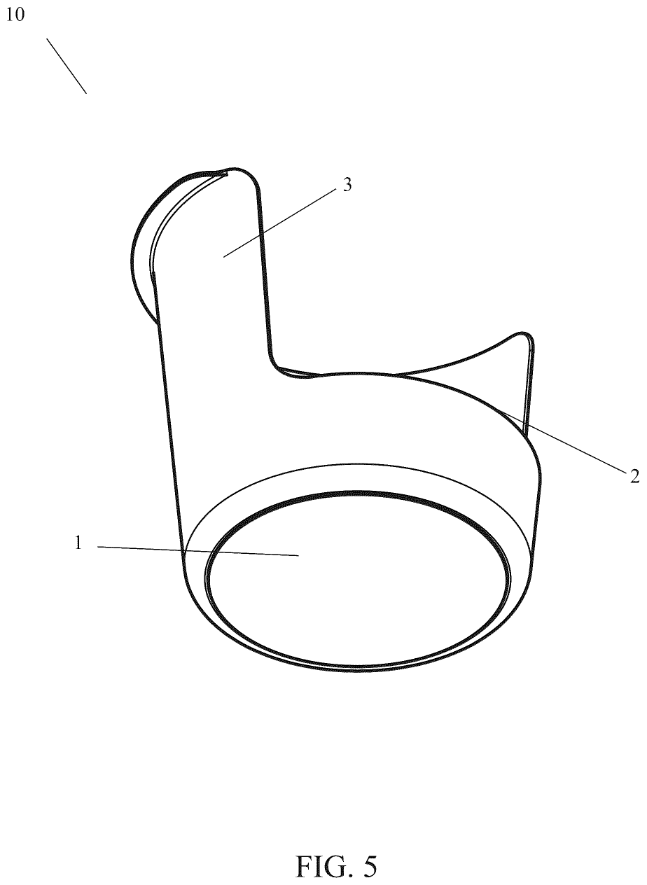

FIG. 6 is an upper-right side offset view for an embodiment of the present invention.

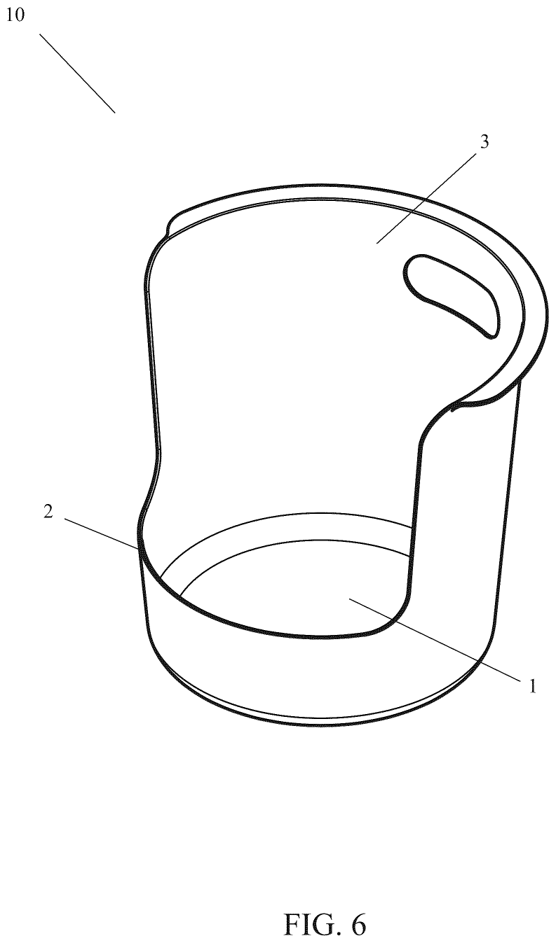

### DETAIL DESCRIPTIONS OF THE INVENTION

All illustrations of the drawings are for the purpose of describing selected versions of the present invention and are not intended to limit the scope of the present invention.

The present invention is a feeding bowl 10 comprising a bowl cavity 1, an access lip 2, and a retaining wall 3. The bowl cavity 1 serves as a receptacle for an animal's food. Typical embodiments will be a circular bowl structure, though polygonal and irregular structures may also be utilized within the scope of the invention. Most of the outer perimeter of the bowl structure extends upward to form the retaining wall 3. The exception is a portion which only extends upward to a lower access lip 2. This lower section, represented by the access lip 2, can be characterized as being cut out from the overall wall structure 3 that would form a uniformly high-walled bowl. The access lip 2 will generally encompass a substantially lesser portion of the bowl cavity 1 perimeter than that encompassed by the retaining wall 3. This structure allows an animal to access the bowl cavity 1 through resulting structure over the access lip 2. The retaining wall 3 also serves to limit any tipping of the bowl 10 that would result from the animal stepping directly on the access lip 2 while the animal is in position for eating from the bowl 10. This is due to the upper portions of the retaining wall 3 not readily tipping past the animal's head while present. The retaining wall 3 serves as a shield from sloppy eating around the portions of the cavity 1 perimeter it encompasses.

Embodiments may also incorporate additional components to provide additional utility or improve efficacy. Embodiments may incorporate a weighting material to aid in tipping prevention functionality. This material will generally be heavier than most or all the other components of the bowl. The typical embodiment will affix a metal plate 4 to the underside of the bowl, lowering its center of gravity. Other embodiments may incorporate the weighting material into some or all of the structure for the bowl cavity itself. Embodiments may also allow for the weighting material to be inside the bowl cavity, attached on its upper side. Embodiments will also benefit from non-skid material 5 on bottom of the bowl 10. The non-skid material 5 may encompass wholly or in part the underside of the bowl cavity 1. The preferred embodiment would affix the non-skid material 5 to the underside of the metal plate 4, obscuring the plate 4 from view. Other embodiments may also incorporate additional components to wholly or partially close off access to the bowl. A roof over the retaining wall which would still allow access to the section created through the access lip would serve as potential embodiments. Such a roof may be affixed or a removable lid structure in different embodiments. A removable cover for the access section (with or without considering a roof structure) would also be within the scope of the invention, allowing restriction of access while not in use.

Although the invention has been explained in relation to its preferred embodiment, it is to be understood that many other possible modifications and variations can be made without departing from the spirit and scope of the invention.

1. A feeding bowl comprising:
a bowl cavity;
an access lip; and
a retaining wall;
wherein
the perimeter of the bowl cavity extends upward from its base to form the access lip and the retaining wall;
the retaining wall is a single section which extends upward from the perimeter of the bowl cavity;
the top of the access lip is a single section on the perimeter of the bowl cavity which extends upward to a substantially lower point than the top of the retaining wall, providing access to the bowl cavity through its section; and
the access lip encompasses a lesser proportion of the bowl cavity's perimeter than that encompassed by the retaining wall, only facilitating access from a single direction.

2. The bowl of claim 1, further comprising a roof structure wherein the roof structure spans the upper edges of the retaining wall, substantially covering the corresponding area over the bowl cavity without interfering with access through the section encompassed by the lower lip.

3. The bowl of claim 2, wherein the roof structure is a lid removably connected to the top of the retaining wall.

4. The bowl of claim 1, wherein a non-skid material is affixed to the underside portion of the bowl cavity.

5. The bowl of claim 1, further comprising a weighting material wherein the weighting material is of a heavier material than that used in the other components of the bowl and the material is connected to the bowl cavity to lower the center of gravity for the whole of the bowl's structure.

6. The bowl of claim 5, wherein the weighting material is a metal plate encompassing a substantial portion the underside portion of the bowl cavity's surface area and which is affixed to the bottom the bowl cavity.

7. The bowl of claim 6, wherein a non-skid material is affixed to the underside portion of the metal plate.
